(19) United States
(12) Patent Application Publication
(10) Pub. No.: US 2013/0069614 A1
(43) Pub. Date: Mar. 21, 2013

(54) POWER SUPPLY CIRCUIT AND POWER SUPPLY CIRCUIT WITH ADAPTIVELY ENABLED CHARGE PUMP

(71) Applicants: Chung-Hsien Tso, Taipei City (TW); Wei-Hsin Wei, Zhubei City (TW); Kuo-Chen Tsai, Zhubei City (TW); Shui-Mu Lin, Taichung City (TW); Yu-Chia Hsu, Tainan City (TW); Wei-Chuan Wu, Hemei Township (TW)

(72) Inventors: Chung-Hsien Tso, Taipei City (TW); Wei-Hsin Wei, Zhubei City (TW); Kuo-Chen Tsai, Zhubei City (TW); Shui-Mu Lin, Taichung City (TW); Yu-Chia Hsu, Tainan City (TW); Wei-Chuan Wu, Hemei Township (TW)

(73) Assignee: Richtek Technology Corporation

(21) Appl. No.: 13/466,791

(22) Filed: May 8, 2012

(30) Foreign Application Priority Data
Sep. 15, 2011 (TW) 100133269

(51) Int. Cl. G05F 1/10

(52) U.S. Cl. 323/288

(57) ABSTRACT

The present invention discloses a power supply circuit with adaptively enabled charge pump. The power supply circuit includes: a buck switching regulator switching at least one power switch therein to convert an input voltage to a middle voltage according to a control signal; a charge pump coupled to the buck switching regulator, wherein when the charge pump is enabled, the charge pump boosts the middle voltage to provide an output voltage higher than the middle voltage, and when the charge pump is disabled, the middle voltage is supplied as the output voltage; and a controller generating the control signal to control the switching regulator, and determining to enable or disable the charge pump according to a level of the input voltage.

### CROSS REFERENCE

The present invention claims priority to TW 100133269, filed on Sep. 15, 2011.

### BACKGROUND OF THE INVENTION

1. Field of Invention

The present invention relates to a power supply circuit, in particular to a power supply circuit including a buck switching regulator and a charge pump, wherein the charge pump is adaptively enabled according to a level of an input voltage.

2. Description of Related Art

FIG. 1 shows a schematic diagram of a prior art power supply circuit which generates an output voltage Vld from a battery and supplies the output voltage to a load circuit, wherein the load circuit is, for example, a display panel of a portable electronic device. As shown in the figure, the power supply circuit essentially includes two converters: a buck switching regulator 11 at the system side and a boost switching regulator 12 at the panel side. The buck switching regulator 11 receives an input voltage Vin and switches at least one power transistor therein to convert the input voltage Vin to a middle voltage Vm which is not higher than the output voltage Vld. The middle voltage Vm is supplied through a wire in a printed circuit board (PCB) to the panel side. The boost switching regulator 12 switches at least one power transistor therein to convert the middle voltage Vm to the output voltage Vld to provided a regulated voltage to the load circuit. The reason for the prior art to use a buck switching regulator and a boost switching regulator together is because the input voltage Vin usually comes from a battery, and the battery voltage will drop. That is, in the beginning, the input voltage Vin is higher than the output voltage Vld, but after a certain while, the input voltage Vin will drop to a level lower than the output voltage Vld. Therefore, the buck switching regulator 11 is provided for converting the input voltage Vin to the middle voltage Vm which has a known and controllable level, so that the boost switching regulator 12 can generate the output voltage Vld from the middle voltage Vm under any condition of the input voltage Vin.

The above prior art power supply circuit requires a boost switching regulator 12, and it consumes more power because it requires two power conversion stages. In addition, because it requires a relatively long transmission wire for the voltage Vm to be transmitted from the system side to the panel side and the current amount is large after buck conversion, the power consumption by the transmission wire (having an equivalent resistance Rpcb) is significant. Thus, it is desired to reduce the power consumption so as to extend the battery life

In the view of above, four prior art power supply circuits are proposed, respectively shown in FIGS. 2-5. However, these four power supply circuits have their respective drawbacks. FIG. 2 shows a prior art power supply circuit according to U.S. Pat. No. 7,411,316, wherein the power supply circuit includes a controller 14 and dual input voltages VDD and VPP. If one of input voltage is lower than the output voltage Vld, the power supply circuit switches to the other input voltage to keep itself operating in buck mode. However, the prior art in FIG. 2 is only applicable to a power supply with dual input voltages VDD and VPP, and it is not applicable to a power supply with single input voltage.

FIG. 3 is another prior art power supply circuit proposed by the applicant of the present invention, wherein when the input voltage Vin (that is, the battery voltage) is higher than a threshold voltage and is sufficient to generate the output voltage Vld in buck mode, a controller 14 controls a first buck switching regulator 15 to convert the input voltage Vin to the output voltage Vld, and when the input voltage Vin is not higher than the threshold voltage, the power supply circuit boosts the input voltage Vin by the charge pump 13 (the input voltage of the charge pump 13 comes from one of the voltages Vpp1−-Vppn), and a second buck switching regulator 16 converts the output voltage from the charge pump 13 to the output voltage Vld. However, in the prior art shown in FIG. 3, one additional power switch 161 is required for the power supply to switch between different modes, and the controller 14 has to control the charge pump 13, the first buck switching regulator 15 and the second buck switching regulator 16. Therefore, the circuit is more complex in this prior art.

FIG. 4 shows another prior art power supply circuit which converts power by a buck-boost switching regulator. However, during operation in this prior art, if the input voltage Vin is close to the output voltage Vld, the circuit would operate in a buck-boost mode wherein all four power switches have to switch frequently; under such circumstance, the power supply circuit consumes more power and the power utilization efficiency is low.

FIG. 5 shows another prior art power supply circuit proposed by the applicant of the present invention, wherein when the input voltage Vin (that is, the battery voltage) is higher than a threshold voltage and is sufficient to generate the output voltage Vld in buck mode, a switch SW is turned off and a controller 14 controls a buck switching regulator 17 to convert the input voltage Vin to the output voltage Vld. When the input voltage Vin is lower than the threshold voltage, the switch SW is turned on and the controller 14 boosts the input voltage Vin to generate a middle voltage Vm by a boost switching regulator 18, and then middle voltage Vm is converted to the output voltage Vld through buck conversion by the buck switching regulator 17. However, the prior art in FIG. 5 requires an additional inductor.

In view of above, the present invention proposes a power supply circuit with adaptively enabled charge pump, which can adaptively switch between different modes according to the input voltage to optimize the operation of the power supply circuit, and all of the drawbacks in the aforementioned prior art circuits are eliminated.

### SUMMARY OF THE INVENTION

An objective of the present invention is to provide a power supply circuit.

Another objective of the present invention is to provide a power supply circuit with adaptively enabled charge pump.

To achieve the foregoing objectives, in one perspective of the present invention, it provides a power supply circuit, comprising: a buck switching regulator switching at least one power switch therein to convert an input voltage to a middle voltage according to a control signal; a charge pump receiving the middle voltage from the buck switching regulator, and boosting the middle voltage to provide an output voltage which is higher than the middle voltage; and a controller generating the control signal to control the buck switching regulator.

In the foregoing power supply circuit, the charge pump may be a fixed or variable multiple charge pump.

In the foregoing power supply circuit, the controller preferably controls the at least one power switch according to the output voltage.

In another perspective of the present invention, it provides a power supply circuit with adaptively enabled charge pump, comprising: a buck switching regulator switching at least one power switch therein to convert an input voltage to a middle voltage according to a control signal; a charge pump coupled to the buck switching regulator, wherein when the charge pump is enabled, the charge pump boosts the middle voltage to provide an output voltage higher than the middle voltage, and when the charge pump is disabled, the middle voltage is supplied as the output voltage; and a controller generating the control signal to control the switching regulator, and determining to enable or disable the charge pump according to a level of the input voltage.

In the foregoing power supply circuit with adaptively enabled charge pump, the controller preferably controls the at least one power switch according to the output voltage.

The foregoing power supply circuit with adaptively enabled charge pump may further include: a mode selection circuit generating a mode selection signal according to the level of the input voltage, and the controller can determine to enable or disable the charge pump according to the mode selection signal.

In the foregoing power supply circuit with adaptively enabled charge pump, when the input voltage is higher than the output voltage, the charge pump is preferably disabled.

In one embodiment, the charge pump may include a first switch, a second switch, a third switch, a fourth switch and a capacitor. The capacitor includes a first terminal and a second terminal; the first switch is coupled between the first terminal and the middle voltage; the second switch is coupled between the first terminal and the output voltage; the third switch is coupled between the second terminal and the ground; the fourth switch is coupled between the second terminal and the middle voltage. When the charge pump is disabled, the first switch, the second switch and the third switch are turned on while the fourth switch is turned off; when the charge pump is enabled, the first switch and the third switch are turned on while the second switch and the fourth switch are turned off in a first time phase, and the first switch and the third switch are turned off while the second switch and the fourth switch are turned on in a second time phase.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art power supply circuit.

FIG. 2 shows a schematic diagram of another prior art power supply circuit.

FIG. 3 shows a schematic diagram of another prior art power supply circuit.

FIG. 4 shows a schematic diagram of another prior art power supply circuit.

FIG. 5 shows a schematic diagram of another prior art power supply circuit.

FIG. 6 shows a first embodiment according to the present invention.

FIG. 7A shows a second embodiment according to the present invention.

FIG. 7B shows an embodiment for detecting a level of an input voltage according to the present invention.

FIG. 7C shows that the buck switching regulator can be replaced by an asynchronous buck switching regulator.

FIG. 8 shows a more concrete embodiment according to the present invention.

FIGS. 9A-9C show a two-fold charge pump as an example to explain the operations of the present invention.

### DESCRIPTION OF THE PREFERRED EMBODIMENTS

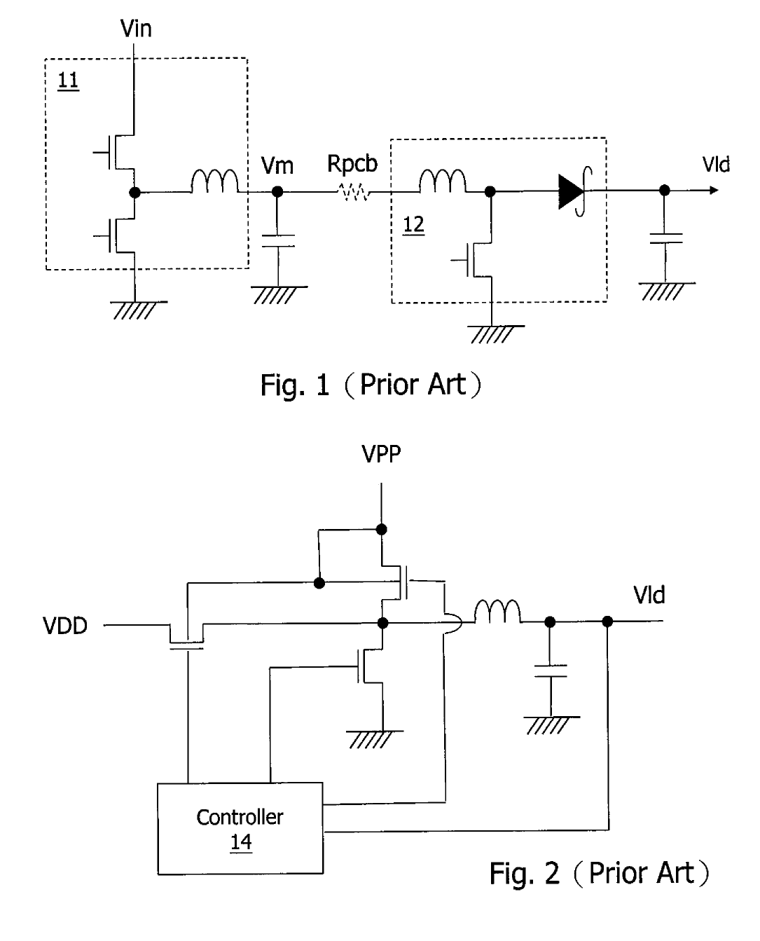

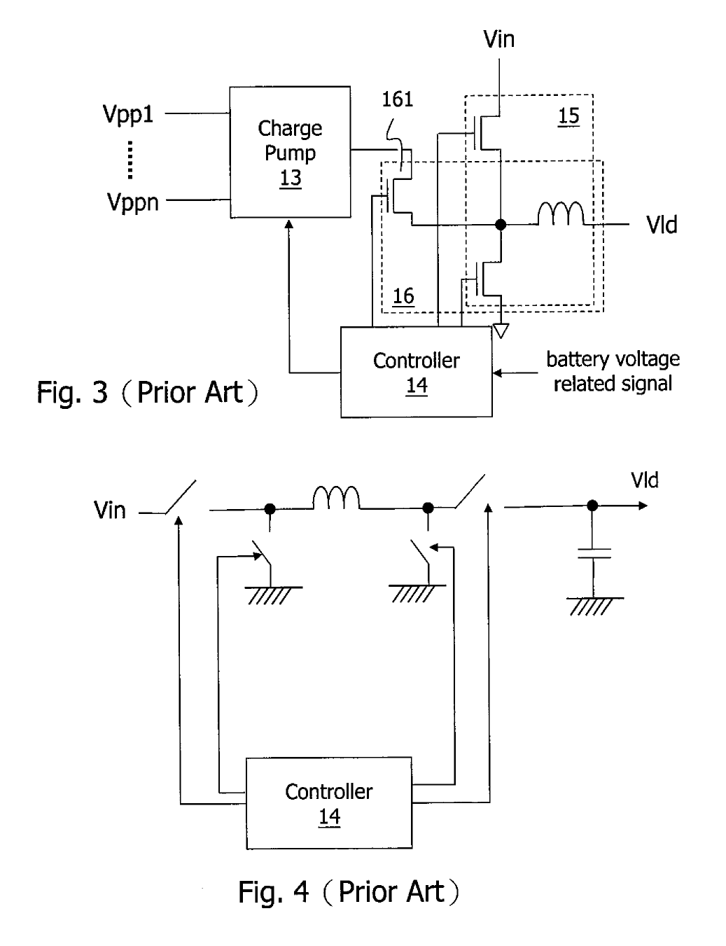

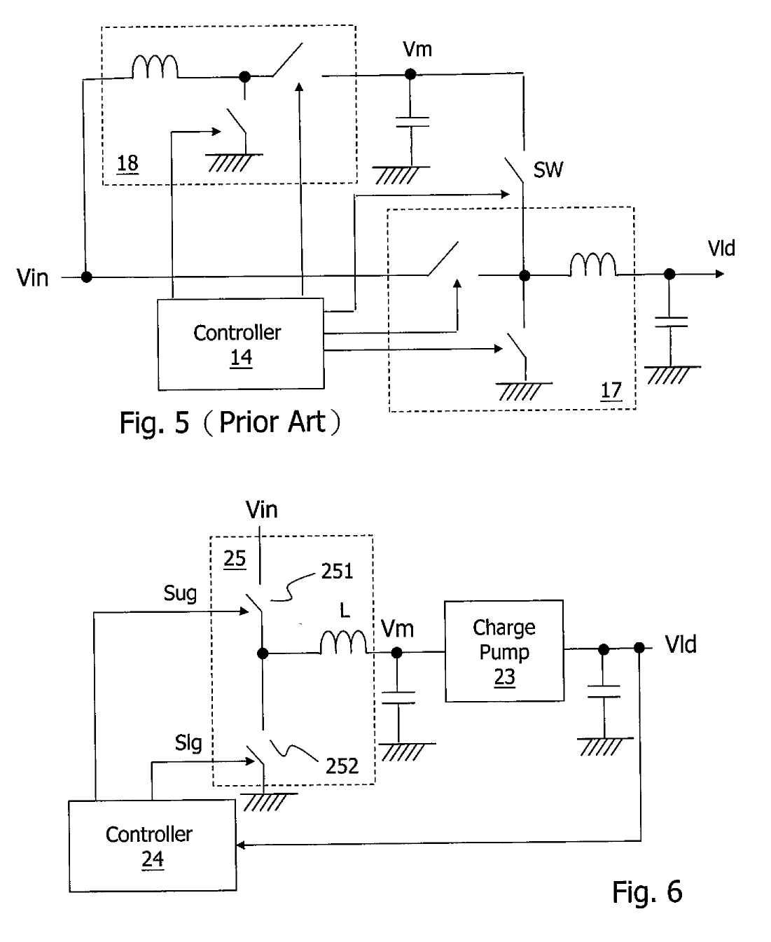

Please refer to FIG. 6 for a first embodiment of the present invention. As shown in FIG. 6, a power supply of the present invention includes: a charge pump 23, a controller 24 and a buck switching regulator 25. The buck switching regulator 25 switches power switches 251 and 252 to convert an input voltage Vin to a middle voltage Vm according to control signals Sug and Slg; the controller 24 generates the control signals Sug and Slg for controlling the switching regulator 25; the charge pump 23 receives the middle voltage Vm from the buck switching regulator 25 and performs a boost conversion to generate an output voltage Vld. The charge pump in this embodiment provides better power conversion efficiency than the boost switching regulators in FIGS. 1, 4 and 5. In addition, this embodiment is applicable to single input voltage, so it is better than the prior art in FIG. 2. Further, compared with the prior art shown in FIG. 3, this embodiment does not require an additional power switch 161, so it is less complex than the prior art in FIG. 3.

FIG. 6 also shows that the controller 24 obtains a feedback signal from the output voltage Vld (the feedback signal can be the output voltage Vld itself or a divided voltage of the output voltage Vld) to control the power switches 251 and 252. This arrangement has an advantage that the output voltage Vld can be directly regulated to a desired level. Another way is to obtain the feedback signal from the middle voltage Vm to control the power switch 251 and 252, and then the charge pump 23 generates the output voltage Vld according to the regulated middle voltage Vm. However, the arrangement shown in FIG. 6 is preferred.

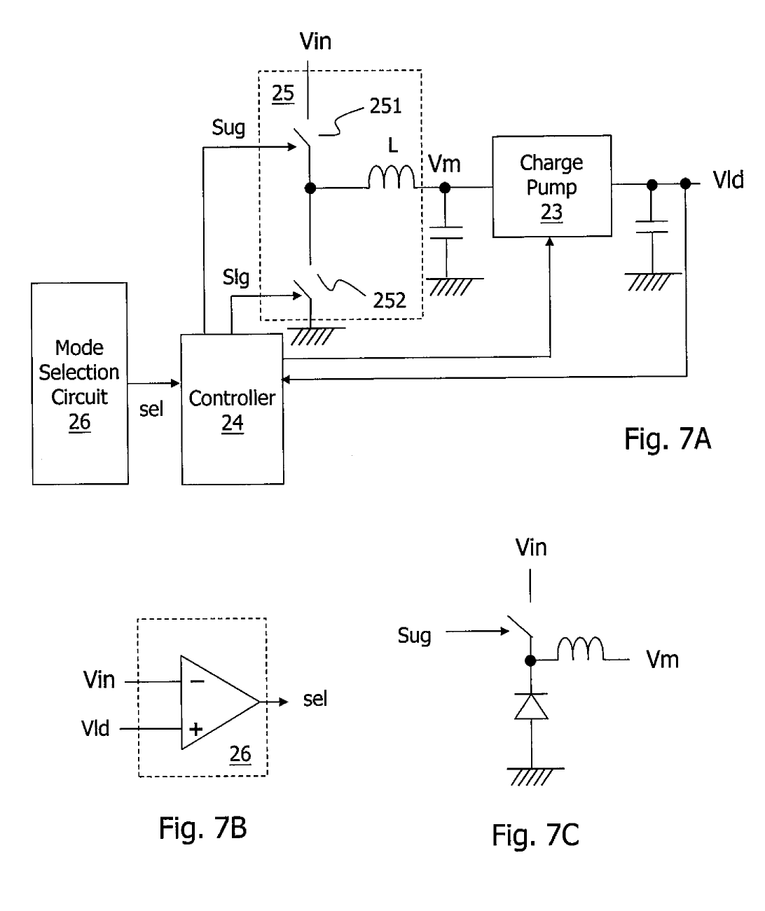

Please refer to FIG. 7A which shows a second embodiment of the present invention. As shown in FIG. 7A, a power supply with adaptively enabled charge pump of the present invention includes: a charge pump 23, a controller 24, a buck switching regulator 25 and a mode selection circuit 26. The buck switching regulator 25 switches power switches 251 and 252 according to control signals Sug and Slg, to convert the input voltage Vin to the middle voltage Vm. The controller 24 generates control signals Sug and Slg for controlling the switching regulator 25, and determines to enable or disable the charge pump 23 according to a level of the input voltage Vin. When the charge pump 23 is enabled, it receives the middle voltage Vm from the buck switching regulator 25 and perform a boost conversion to generate an output voltage Vld. When the charge pump 23 is disabled, the middle voltage Vm is directly supplied as the output voltage Vld. The mode selection circuit 26 generates a mode selection signal sel, and the controller 24 determines to enable or disable the charge pump according to the mode selection signal sel. More specifically, the mode selection signal sel indicates whether the input voltage Vin is higher than a voltage level. When the input voltage Vin is higher than the voltage level, it means that the output voltage Vld can be generated from the input voltage vin by buck conversion, so the middle voltage Vm is directly supplied as the output voltage Vld; when the input voltage Vin is not higher than the voltage level, the middle voltage Vm generated from the input voltage vin by buck conversion should preferably be boosted by the charge pump 23 to provide the output voltage Vld.

FIG. 7B shows one embodiment of the mode selection circuit 26 according to the present invention, wherein the mode selection circuit 26 includes a comparator 261 comparing the input voltage Vin with the output voltage Vld to generate the mode selection signal sel. It should be explained that what is illustrated in this embodiment, that is, the comparator 261 compares the input voltage Vin with the output voltage Vld, is just an example for the purpose of illustrating that the mode selection signal sel is generated according to a relative relation between the input voltage Vin and the output voltage Vld. The comparator 261 can generate the mode selection signal sel by other ways instead of comparing the input voltage Vin with the output voltage Vld, such as by comparing a divided voltage of the input voltage Vin with a divided voltage of the output voltage Vld; further, a positive or negative bias voltage can be added to any input terminal of the comparator 261, that is, the comparator 261 can compare (Vin+ΔV) with Vld, Vin with (Vld+ΔV), [(a divided voltage of Vin)+ΔV] with (a divided voltage of Vld), or (a divided voltage of Vin) with (a divided voltage of (Vld+ΔV)), etc., wherein ΔV can be positive or negative. Moreover, the mode selection signal is not necessarily generated according to the relative relation between the input voltage Vin and the output voltage Vld; instead, it can be generated by comparing the input voltage vin or its divided voltage with a predetermined reference voltage.

The buck switching regulator 25 in FIG. 7A is a synchronous buck switching regulator including two power switches 251 and 252, but it can be replaced by an asynchronous buck switching regulator shown in FIG. 7C.

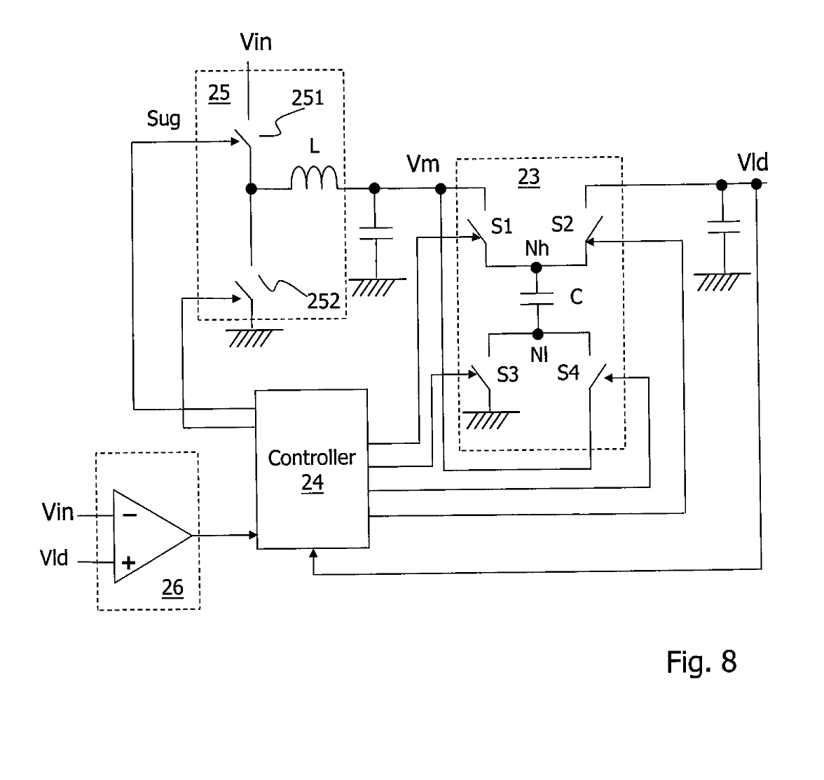

FIG. 8 shows a more concrete embodiment of the present invention. As shown in FIG. 8, the charge pump 23 in this embodiment includes four switches S1, S2, S3, S4 and a capacitor C, wherein each one of the switches 51, S2, S3, S4 can be a P-type metal oxide semiconductor field effect transistor (MOSFET) or an N-type MOSFET. The first switch S1 is coupled between an upper terminal Nh of the capacitor C and the middle voltage Vm; the second switch S2 is coupled between the upper terminal Nh and the output voltage Vld; the third switch S3 is coupled between a lower terminal Nl of the capacitor C and the ground; and the fourth switch S4 is coupled between the lower terminal Nl and the middle voltage Vm. It should be explained that the embodiment in FIG. 8 is only an example which should not be taken as a limitation to the present invention; in fact, the charge pump 23 of the present invention can be a fixed or variable multiple charge pump (a fixed charge pump generated an output voltage having a fixed ratio to its input voltage, while a variable multiple charge pump can generated different output voltages with different ratios to its input voltage), and the output voltage of the charge pump is not necessarily two-fold of the input voltage of the charge pump.

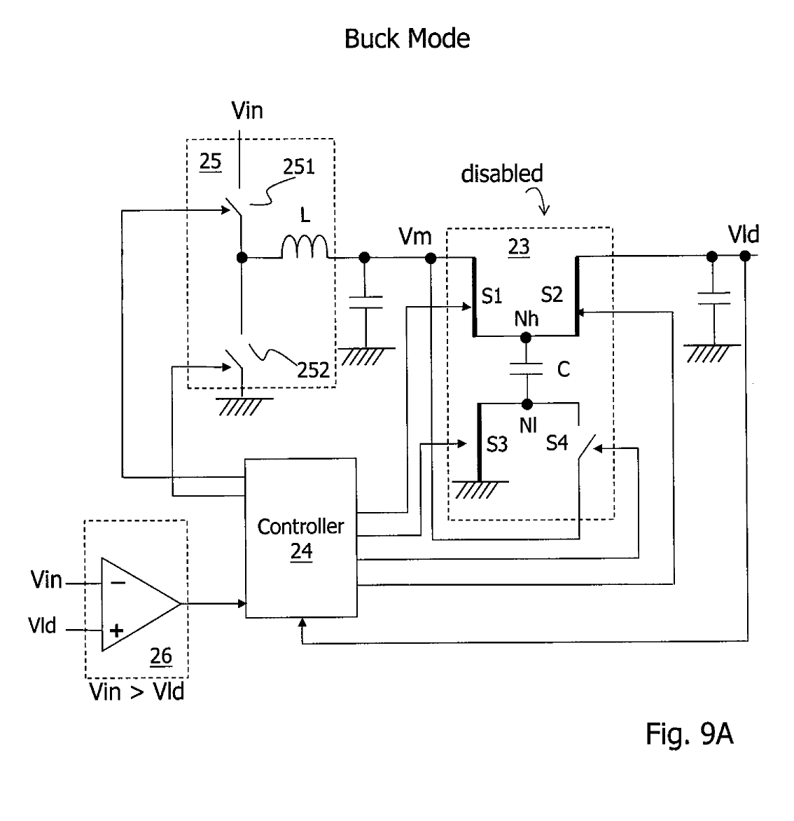

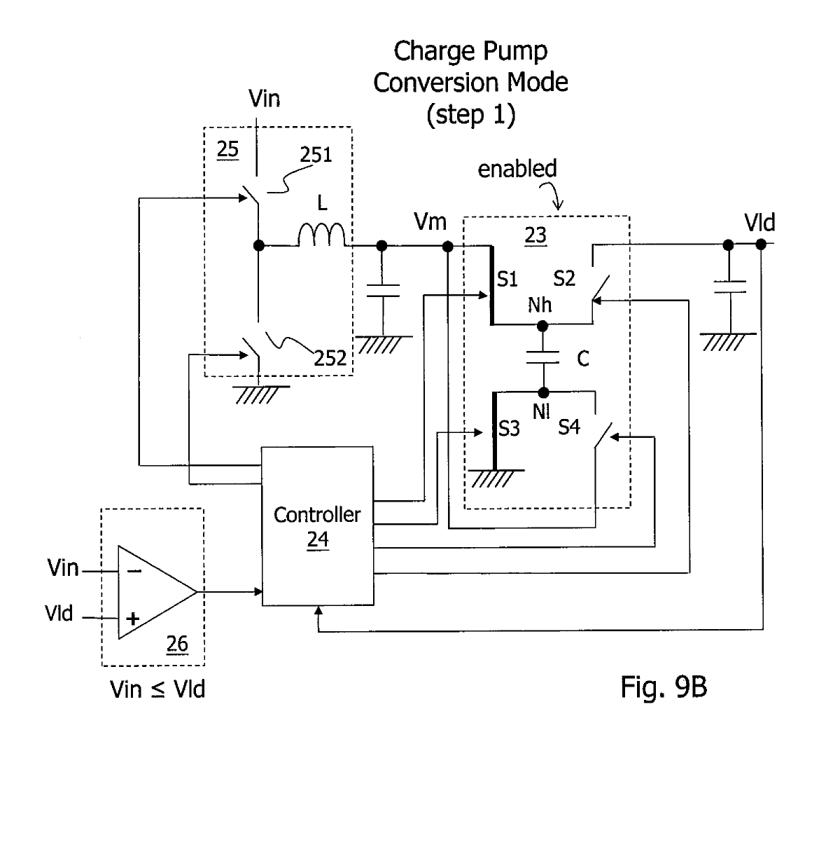

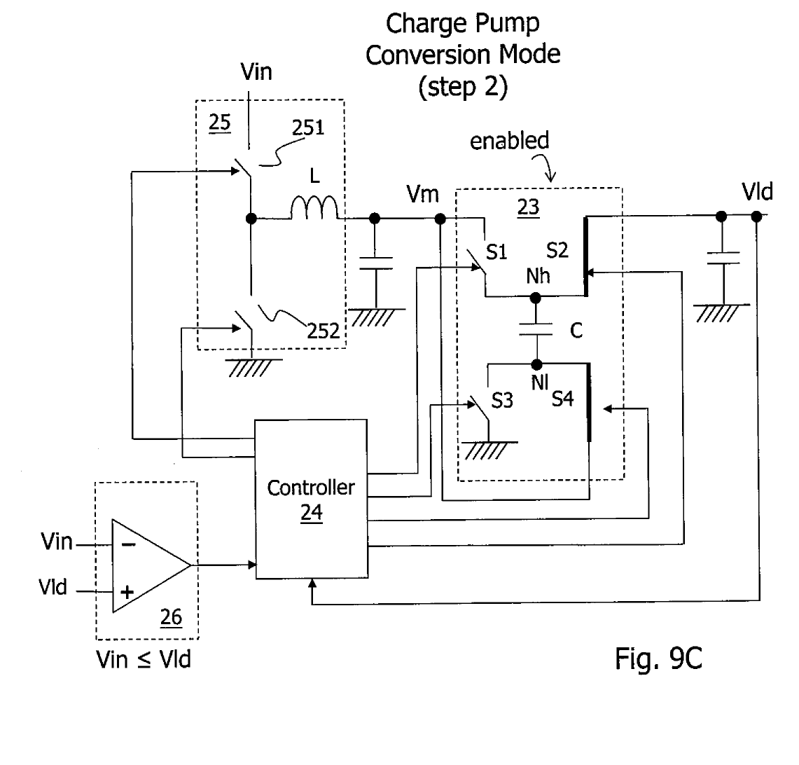

FIGS. 9A-9C show the operations of the embodiment in FIG. 8, basically as the followings: Assume that the mode selection circuit 26 generates the mode selection signal sel according to the relative relation between the input voltage Vin and the output voltage Vld. When the input voltage Vin is higher than the output voltage Vld (it means that the input voltage Vin is sufficient to generate the output voltage Vld by buck conversion), the power supply circuit converts the input voltage Vin to the middle voltage Vm by the buck switching regulator 25 and supplies the middle voltage Vm as the output voltage Vld. When the input voltage Vin is not higher than the output voltage Vld, the charge pump 23 boosts the middle voltage Vm to generate the output voltage Vld. FIG. 9A shows a case that the input voltage Vin is higher than the output voltage Vld, and FIGS. 9B-9C shows a case that the input voltage Vin is not higher than the output voltage Vld. In FIG. 9A, the input voltage Vin is higher than the output voltage Vld and is sufficient to generate the output voltage Vld by buck conversion; therefore, the switches S1, S2, S3 are turned on so that the middle voltage Vm is directly supplied as the output voltage Vld, but the switch S4 is turned off to disable the charge pump 23. It should explained that “to disable the charge pump 23” does not mean that there is absolutely no current flowing through the charge pump 23, but means that there is no boost effect while the current flows through the charge pump 23 (that is, the charge pump 23 does not perform the boost conversion). In FIGS. 9B-9C, the input voltage Vin is not higher than the output voltage Vld and is not sufficient to generate the output voltage Vld by buck conversion; therefore, the charge pump 23 needs to function to generate the output voltage Vld by boosting the middle voltage Vm. FIG. 9B shows a first step for the charge pump 23 to perform the boost conversion, wherein the switches S1 and S3 are turned on while the switches S2 and S4 are turned off so that the capacitor C is charged to a voltage level equal to the middle voltage Vm. FIG. 9C shows a second step for the charge pump 23 to perform the boost conversion, wherein the switches S2 and S4 are turned on while the switches S1 and S3 are turned off so that the capacitor voltage is added to the middle voltage Vm; therefore, the voltage Vld is equal to two times of the middle voltage vm (that is, Vld=2*Vm), so the middle voltage Vm is boosted to supply the output voltage Vld. Note that the order of the first step and the second step can be interchanged. FIGS. 9A-9C shows a two-fold charge pump, which is only as an example for the purpose of illustration, not for limiting the scope of the present invention. Other types of charge pumps can be used.

Compared with the prior art, the present invention can directly convert Vin to Vld without requiring a buck conversion at the system side followed by a boost conversion at the panel side, so the present invention can significantly reduce the power consumption caused by the resistance Rpcb of the wire and has better power utilization efficiency than the prior art. In addition, it is not required for the present invention to frequently switch the power switches, so the present invention can provide better efficiency and stability than the prior art. Further, the present invention neither requires dual or multiple input voltages, nor requires additional switch or inductor, so it can be applied to a boarder range of applications and has a lower cost. In view of the above, the present invention is superior to all the aforementioned prior art.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the charge pump 23 can be replaced by other types of charge pumps. As another example, a device which does not affect the primary functions of the circuits can be interposed between two devices or circuits shown to be in direct connection in the illustrated embodiments, such as other switches. As yet another example, the positive and negative input terminals of a comparator can be swapped as long as corresponding modifications are made so that the input and output signals of the comparator are properly processed to provide a desired function. Thus, the present invention should cover all such and other modifications and variations, which should be interpreted to fall within the scope of the following claims and their equivalents.

What is claimed is:

1. A power supply circuit, comprising:
a buck switching regulator switching at least one power switch therein to convert an input voltage to a middle voltage according to a control signal;
a charge pump receiving the middle voltage from the buck switching regulator, and boosting the middle voltage to provide an output voltage which is higher than the middle voltage; and
a controller generating the control signal to control the buck switching regulator.

2. The power supply circuit of claim 1, wherein the charge pump is a fixed or variable multiple charge pump.

3. The power supply circuit of claim 1, wherein the controller controls the at least one power switch according to the output voltage.

4. A power supply circuit with adaptively enabled charge pump, comprising:
a buck switching regulator switching at least one power switch therein to convert an input voltage to a middle voltage according to a control signal;
a charge pump coupled to the buck switching regulator, wherein when the charge pump is enabled, the charge pump boosts the middle voltage to provide an output voltage higher than the middle voltage, and when the charge pump is disabled, the middle voltage is supplied as the output voltage; and
a controller generating the control signal to control the switching regulator, and determining to enable or disable the charge pump according to a level of the input voltage.

5. The power supply circuit of claim 4, wherein the controller controls the at least one power switch according to the output voltage.

6. The power supply circuit of claim 4, wherein when the input voltage is higher than the output voltage, the charge pump is disabled.

7. The power supply circuit of claim 4, further comprising:
a mode selection circuit generating a mode selection signal according to the level of the input voltage, and wherein the controller determines to enable or disable the charge pump according to the mode selection signal.

8. The power supply circuit of claim 7, wherein the mode selection circuit includes a comparator which generates the mode selection signal by comparing:
(1) the input voltage with the output voltage,
(2) a divided voltage of the input voltage with a divided voltage of the output voltage,
(3) the sum of the input voltage and a bias voltage with the output voltage,
(4) the input voltage with the sum of the output voltage and a bias voltage,
(5) the sum of a divided voltage of the input voltage and a bias voltage with a divided voltage of the output voltage,
(6) a divided voltage of the input voltage with the sum of a divided voltage of the output voltage and a bias voltage,
(7) the input voltage with a reference voltage, or
(8) a divided voltage of the input voltage with a reference voltage.

9. The power supply circuit of claim 4, wherein the charge pump is a fixed or variable multiple charge pump.

10. The power supply circuit of claim 4, wherein the charge pump includes a first switch, a second switch, a third switch, a fourth switch and a capacitor,
the capacitor including a first terminal and a second terminal,
the first switch being coupled between the first terminal and the middle voltage,
the second switch being coupled between the first terminal and the output voltage,
the third switch being coupled between the second terminal and the ground,
the fourth switch being coupled between the second terminal and the middle voltage;
wherein when the charge pump is disabled, the first switch, the second switch and the third switch are turned on while the fourth switch is turned off; and
wherein when the charge pump is enabled, the first switch and the third switch are turned on while the second switch and the fourth switch are turned off in a first time phase, and the first switch and the third switch are turned off while the second switch and the fourth switch are turned on in a second time phase.
